(19) United States
(12) Patent Application Publication
(10) Pub. No.: US 2026/0166707 A1
(43) Pub. Date: Jun. 18, 2026

(54) KNIFE WITH STORAGE

(71) Applicant: Outdoor Edge Cutlery, LLC, Maple Grove, MN (US)

(72) Inventors: Andrew Engstrom, Maple Grove, MN (US); Mike Feesl, Inver Grove Heights, MN (US); Ryan Chernik, New Brighton, MN (US); Ryan Jacobson, Andover, MN (US)

(73) Assignee: Outdoor Edge Cutlery, LLC, Maple Grove, MN (US)

(21) Appl. No.: 19/419,688

(22) Filed: Dec. 15, 2025

Related U.S. Application Data
(60) Provisional application No. 63/733,533, filed on Dec. 13, 2024.
(60) Provisional application No. 63/735,435, filed on Dec. 18, 2024.

(51) Int. Cl. B25G 1/08; B26B 5/00; B26B 29/02

(52) U.S. Cl. CPC B25G 1/08; B26B 5/00; B26B 29/025

(57) ABSTRACT

A knife is provided that includes a blade, a tang, and handle storage. The blade can be a replaceable blade that is transiently attached to a blade carrier, and the blade carrier can be fixedly interconnected to a handle. The knife further includes a replaceable blade lock release button, and the tang is a skeleton tang. The handle storage comprises two storage cavities. Each storage cavity has a corresponding lid that connects to the storage cavity using a rim/lip sealing mechanism, and each storage cavity includes at least one embedded magnet. The handle storage is removable from the skeleton tang.

### FIELD OF THE INVENTION

Embodiments of the present invention generally relate to knives. More specifically, one embodiment of the present invention is a knife that has a blade element and storage in the handle.

### BACKGROUND OF THE INVENTION

Knives are usually comprised of a handle with a blade that is interconnected thereto. Some knives employ blades that are rotatably interconnected, and selectively lockable, to the handle. Other knives are fixed-blade knives that do not rotate and transiently lock to the handle. Regardless of knife type, it is desirable to provide a cutting edge that is very sharp, similar to the sharpness provided by a razor blade. However, razor blade sharpness comes at a price. More specifically, razor blades often possess very thin edges that are brittle and wear, i.e., lose their edge, relatively quickly. Blade performance can be repaired by sharpening, but doing so will reduce blade size and durability. In addition, thin razor blades lack lateral strength and are thus flimsy and can fracture easily when put to hard use to cut forcibly or when cutting at an angle that applies lateral side-force to the blade. Thus, some knives employ a razor-sharp replaceable blade element that fits within a blade carrier, which may be foldable within a handle. Once the replaceable blade element becomes dull, or after repeated sharpening, it can be removed from the blade carrier and discarded. Another replaceable blade element can then be inserted into the carrier. There are times when a blade may need to be replaced when a user may not be at home or otherwise in the vicinity of their normal blade storage. Therefore, it is desirable to provide a knife that can store new and used blades, or potentially other small items, on itself.

The following disclosure describes a knife with a replaceable blade that can store new and used blades within the handle element.

### SUMMARY OF THE INVENTION

It is one aspect of embodiments of the present invention to provide a knife with a blade and handle storage. In an illustrative but non-limiting example, the disclosure provides a knife having a blade; a tang; and handle storage. The handle storage can include two storage cavities, each storage cavity can have a corresponding lid, at least one of the storage cavities can be larger in size than the blade, and the handle storage can be removable from the tang. In some cases, the blade can be a replaceable blade. Further, the knife can include a blade carrier to which the replaceable blade is transiently attached. Additionally, the knife can include a replaceable blade lock release button that, when pushed, enables a user to remove the blade from the knife.

In some cases, the storage cavities can be located on opposing sides of the tang. Further, the knife can include three additional blades, wherein the at least three additional blades may be dimensioned similarly to the blade and fit within one of the storage cavities. In some cases, fasteners can affix the storage cavities to the tang. In such cases, at least two additional blades may be dimensioned similarly to the blade and fit within at least one of the storage cavities, and the additional blades may be positioned laterally outward from the fasteners.

In some cases, the storage cavities may be mirror images of each other such that their positions are not interchangeable on the tang. And in some cases, the knife can include a first locking mechanism to retain the blade. Further, the knife may have a second locking mechanism to fix the first locking mechanism in place and further prevent the blade from separating from the knife.

In some cases, the tang can have a tang frame and a tang interior, the tang frame can be made of a first material, and the tang interior can be made of a second material that is different from the first material. The tang frame may be a skeleton frame, and the tang interior can have a honeycomb pattern.

In some cases, at least one magnet is embedded between the tang and the handle storage. The at least one magnet may be comprised of three magnets, and all three magnets can be located on at least one side of the tang. A first of the three magnets may be located near a distal end of the handle, a second of the three magnets may be located centrally on the handle, and a third of the three magnets can be located near a proximal end of the handle. In some cases, each storage cavity can include at least one magnet.

In some cases, the storage cavities can each have a raised outer lip along an outer edge around which rims on their corresponding lids are securable. Therefore, each lid can have a snap fit connection with its corresponding storage cavity.

In another illustrative but non-limiting example, the disclosure provides a knife comprising a blade carrier, a removable blade connected to the blade carrier, a tang, and at least one storage cavity having a corresponding removable lid. The storage cavity can be removable in its entirety from the knife. The storage cavity can connect to one of the blade carrier or the tang. The storage cavity can have a raised outer lip along an outer edge around which a rim on the corresponding removable lid can be securable such that the lid has a snap fit with the storage cavity.

The Summary of the Invention is neither intended nor should it be construed as being representative of the full extent and scope of the present invention. Moreover, references made herein to “the present invention,” or aspects thereof, should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention, and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a rear perspective view of a knife with handle storage of one embodiment of the present invention.

FIG. 2 is a left side view of one embodiment of the knife with handle storage showing a flat pattern instead of honeycomb pattern for the sheath and handle storage.

FIG. 3 is right side view of one embodiment of the knife with handle storage showing a flat pattern instead of honeycomb pattern for the sheath and handle storage.

FIG. 4 is a top view of one embodiment of the knife with handle storage.

FIG. 5 is a bottom view of one embodiment of the knife with handle storage.

FIG. 6 is a front view of one embodiment of the knife with handle storage.

FIG. 7 is a rear view of one embodiment of the knife with handle storage.

FIG. 8 is a perspective view of one embodiment of the knife with handle storage, wherein the sheath, handle storage, and spare blades have been removed.

FIG. 9 is a perspective view of one embodiment of the knife with handle storage, wherein the sheath, handle storage, and spare blades have been removed.

FIG. 10 is a left side view of one embodiment of the knife with handle storage, wherein the sheath and handle storage have been removed.

FIG. 11 is a top view of the handle storage removed from the knife handle.

FIG. 12 is a left side view of one embodiment of the knife with handle storage with the handle storage removed from the knife handle.

FIG. 13 is a left-side, partial cross-section view of the handle storage removed from the knife as taken from the line 13-13 in FIG. 4, showing the blade storage space.

FIG. 14 is a right-side, partial cross-section view of the handle storage as taken from the line 14-14 in FIG. 5, showing the blades in the blade storage space.

FIG. 15 is a right side view of the handle storage removed from the knife, showing the space where the blades are stored.

FIG. 16 is a left-side view of the right-side handle storage removed from the knife, showing the interior magnets that hold the blades in the storage space.

FIG. 17 is a front, cross-section view of the handle storage, showing placement of the magnets, storage cavity, and fasteners within the handle storage.

FIG. 18 is a right-side view of the left-side handle storage removed from the knife, showing the interior magnet space, the fastener openings, and the guidepost receiving cavities.

FIG. 19 is a right-side view of the left-side handle cover.

FIG. 20 is a left-side view of the right-side handle storage removed from the knife, showing the interior magnet space, the fastener openings, and the guideposts.

FIG. 21 is a partial exploded view illustrating the second locking mechanism in a configuration allowing the first locking mechanism to unlock.

FIG. 22 is a partial right side view of the blade holder illustrating the second locking mechanism fixing the first locking mechanism in place.

FIG. 23 is a bottom view of the blade holder showing the sloped surface of the lock pin of the first locking mechanism.

To assist in the understanding of one embodiment of the present invention, the following list of components and associated numbering found in the drawings is provided herein:

| # | Component |
|---|---|
| 102 | Knife |
| 106 | Handle |
| 110 | Blade |
| 111 | Longitudinal axis |
| 112 | Transverse axis |
| 114 | Blade carrier |
| 115 | First locking mechanism |
| 116 | Flexible tab |
| 117 | Lock pin |
| 118 | Replaceable blade |
| 124 | Cutting edge |
| 130 | Replaceable blade lock |
| | release button |
| 134 | Front blade portion |
| 140 | Hook |
| 144 | Aperture |
| 150 | Blade end |
| 154 | Knife sheath |
| 156a | Sheath frame |
| 156b | Sheath insert |
| 158 | Handle storage |
| 162a/b | Storage cavities |
| 164 | Raised outer lip |
| 166 | Lids |
| 168a | Lid frame |
| 168b | Lid insert |
| 168c | Rim |
| 170 | Magnet |
| 174 | Tang fastener |
| 176 | Tang |
| 178 | Tang frame |
| 180 | Tang interior |
| 182 | Storage fastener |
| 186 | Fastener opening |
| 190 | Guidepost |
| 194 | Guidepost receiving cavity |
| 220 | Second locking mechanism |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

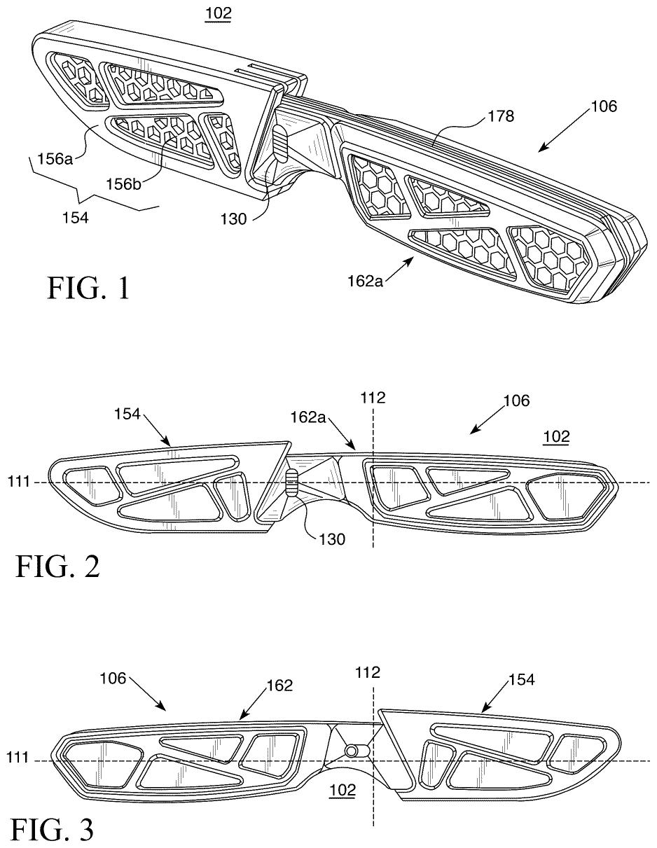

FIGS. 1-10 show a knife 102 of one embodiment of the present invention that includes a handle 106 that is operably interconnected to a blade 110. The handle 106 defines a longitudinal axis 111 and a transverse axis 112. The knife can include the blade 110, a tang 176, and handle storage 158. The handle storage 158 can be comprised of two storage cavities 162a/b on either side of the tang 176, with each storage cavity having a corresponding lid 166. The storage cavities 162a/b can be sized to receive the blade 110 (i.e., they are at least as big, if not bigger than, the blade). Further, the handle storage 158 can be removable from the tang 176 without impacting the usability of the knife 102. FIGS. 11-20 show various components of the knife 102 in more detail to allow for a more thorough understanding of how the above-listed components function.

In some embodiments, the knife 102 can be comprised of a blade carrier 114 that transiently receives a blade 110 or a replaceable blade 118. When components, features, or connection mechanisms herein are described with reference to blade 110 or replaceable blade(s) 118, it is assumed, unless otherwise stated, that those same components, features, or connection mechanisms apply to the other of blade 110 or replaceable blade(s) 118. The blade 110 can be locked in place by a first locking mechanism 115. In one embodiment of the present invention, a locking mechanism 115 can selectively engage an upper portion of the blade carrier 114, wherein a release button 130 can be used to move a pin 117 of the locking mechanism 115 in a lateral direction, which can unseat the pin from the blade carrier 114. The blade 110 and the replaceable blade 118 can have a cutting edge 124, the majority of which may be exposed when the replaceable blade is positioned between a first blade carrier portion 114a and a second blade carrier portion 114b.

To release the blade 110, the user can engage a replaceable blade lock release button 130. The blade 110 can be secured to the carrier 114 on one end by a lock pin 117 and on the other end by a member positioned between the first blade carrier 114a and the second blade carrier 114b that can receive a hook 140 on the blade 110. The member can also include a guide surface that can facilitate interconnection of the blade 110 and the carrier 114.

More specifically, the blade lock release button 130, when depressed, can selectively engage a flexible tab 116 of the blade carrier 114. The tab 116 can also include a lock pin 117. Depression of the release button 130 can deflect the tab 116 and move the lock pin 117 in a lateral direction which can move the lock pin out of an aperture 144 of the blade 118. The flexible tab 116 may further include a recess, indent, or scalloped portion that facilitates deflection. When the obstruction created by the lock pin 117 is removed, the blade 110 can be removed from the blade carriers 114. As illustrated in FIG. 23, the lock pin 117 may have a sloped surface that, when contacted by an inserting blade 110, can deflect the tab 116 so that the blade can be fully inserted. More specifically, sliding the blade 110 in a direction parallel to the longitudinal axis 111 of the knife 102 can engage the blade end 150 of the blade 110 against the sloped surface of the pin 117, which can deflect the tab 116. The blade end 150 may employ a corresponding sloped surface that can interact with the sloped surface of the pin 117, which can facilitate insertion of the blade 110. Once the end portion 150 of the blade 110 is positioned past the lock pin 117, the aperture 144 can be positioned over the lock pin, and the pin can recoil to secure the blade 110.

In one embodiment of the present invention, the first blade carrier portion 114a and the second blade carrier portion 114b can have different widths and/or lengths. More specifically, the first blade carrier portion 114a may have a width/length that is less than the width/length of the second blade carrier portion 114b. In operation, the blade 110 can be abutted against a portion of the second blade carrier portion 114b that extends beyond the width or length of the first blade carrier portion 114a. The offset surface between the blade carrier portions 114a/b can form a ledge that acts as a guide that facilitates interconnection of the blade 110 into the carrier 114. Without this offset surface, the blade 110 must be aligned and inserted directly into the small gap between the first blade carrier 114a and the second blade carrier 114b, thus requiring greater skill and dexterity to facilitate the interconnection of the blade 110 into the carrier 114. In addition, to facilitate interconnection, an end 150 of the blade 110 can be abutted against the guide surface and slid rearwardly until the hook 140 is engaged onto a corresponding portion of the member. In this fashion, a user may limit their grasp to the front blade portion 134 of the blade 110, and safety is enhanced.

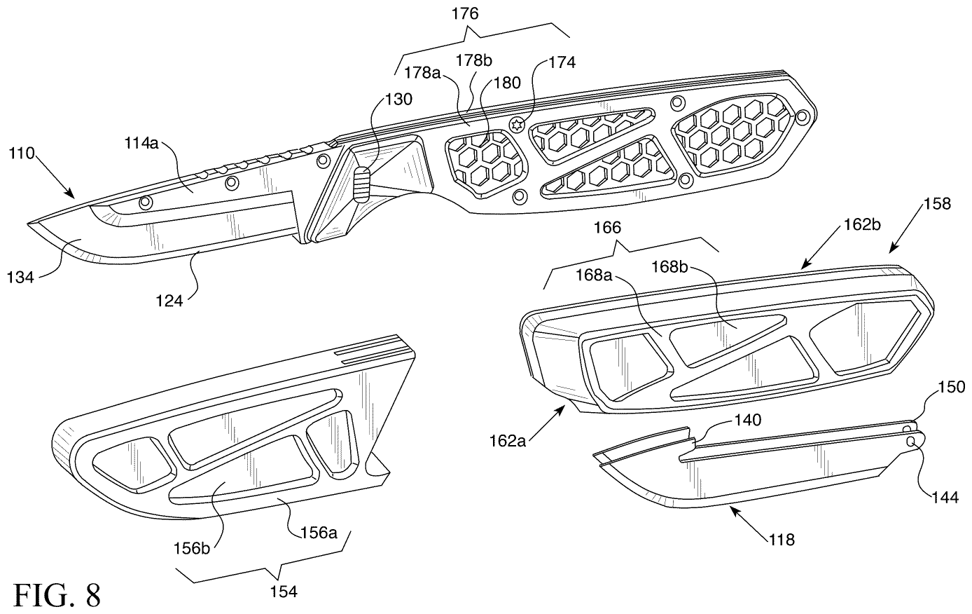

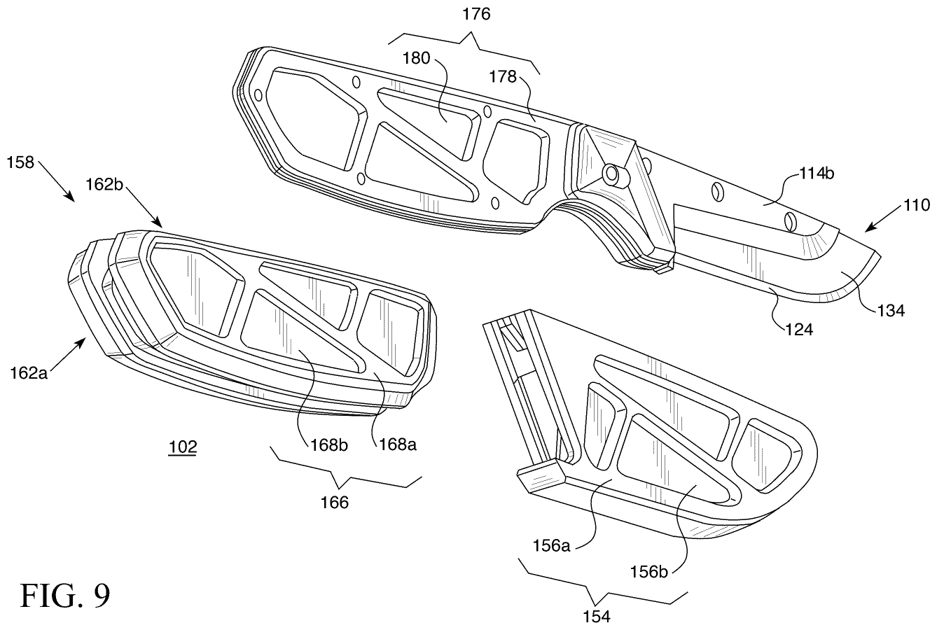

In operation, the blade 110 can be positioned between the first blade carrier 114a and the second blade carrier 114b and the majority of a cutting edge 124 may be exposed and positioned opposite the other wall, as illustrated in FIGS. 8-9. The hook 140 can selectively engage a seat member positioned between the first blade carrier 114a and the second blade carrier 114b and spaced from the upper wall.

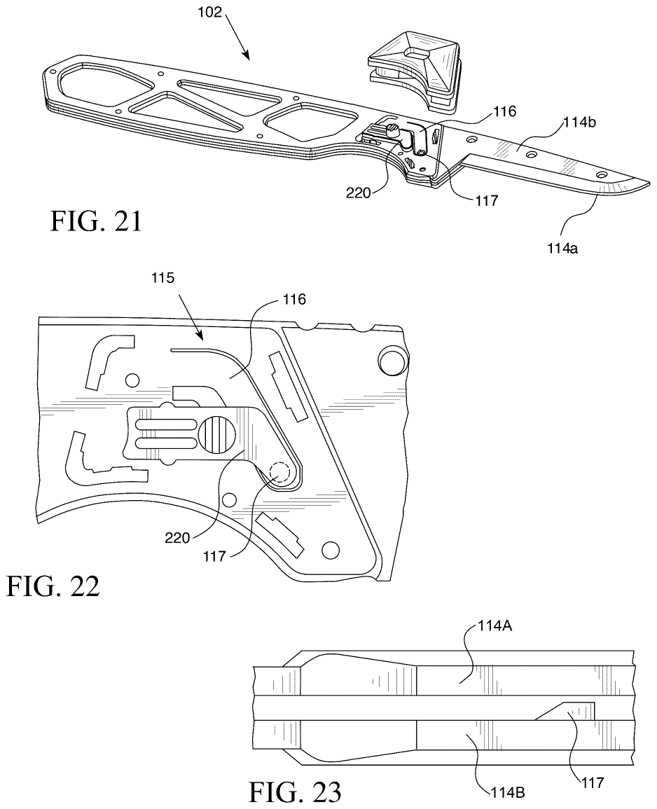

In some embodiments, the blade 110 can be further locked in the blade carriers 114 by a second locking mechanism 220. More specifically, as illustrated in FIGS. 9 and 21-22, the second locking mechanism 220 can be structured and configured to move along axis 111. In FIG. 21, the second locking mechanism 220 is illustrated in an unlocked position. In the unlocked position, the second locking mechanism 220 can be positioned to the proximal end of the knife 102. In such an arrangement, the second locking mechanism 220 may be adjacent to, but not covering, the first locking mechanism 115. In such an arrangement, the first locking mechanism 115 can be moved in a lateral direction via the release button 130, and the blade 110 can be unseated from the blade carrier 114. However, in the locked position, as shown in FIG. 22, the second locking mechanism 220 can be positioned directly over the first locking mechanism 115. The second locking mechanism 220 can achieve such a position by being slid towards the distal end of the knife 102 along the axis 111. In the locked position, the second locking mechanism 220 can be disposed over the flexible tab 116 of the first locking mechanism 115. The second locking mechanism 220 can prevent any lateral movement of the flexible tab 116, thus preventing lateral movement of the tab and thereby preventing the pin 117 from being removed from the blade 110 and the blade from being unseated from the blade carrier 114. In other words, the second locking mechanism 220 can fix the first locking mechanism 115 in place to more securely lock the blade 110 in the knife 102.

The blade 110 of embodiments of the present invention can be made out of high carbon or high carbon stainless steel and may be approximately 2.5-4.0 inches (about 63.5-102 mm) long, although the length of the blade may be shorter or longer; these dimensions should not be considered fixed limitations. The blade carriers 114 can be made of stainless steel and may be spaced about 0.02-0.15 inches (about 0.55-3.8 mm) from each other. However, one of skill in the art will appreciate that the replaceable blade 110/118 and blade carriers 114 may be made of any suitable material.

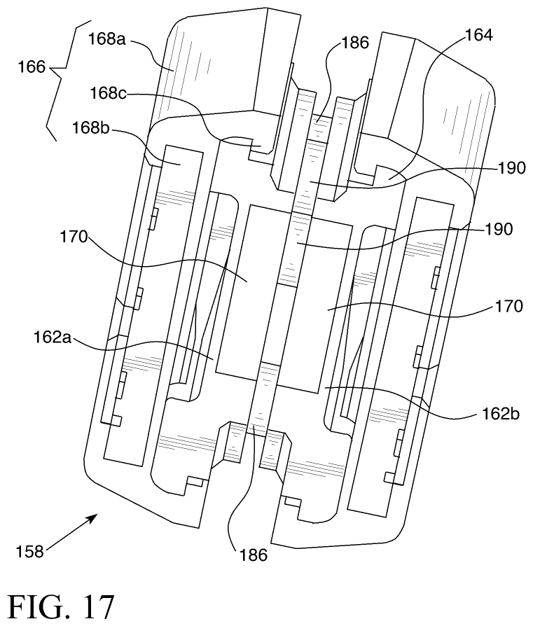

In addition to the blade 110, the knife 102 may further include a knife cover/sheath 154, illustrated in FIGS. 1-10, and handle storage 158, illustrated in FIGS. 7-11 and 13-20. The knife sheath 154 may be sized such that it fits over the blade 110 and blade carrier 114, as illustrated in FIGS. 1-5. As illustrated in FIGS. 6-7, the handle storage 158 may be comprised of two storage cavities 162, one (162a) for the left side of the knife 102 and one (162b) for the right side of the knife 102, within which replacement blades 118 can be stored. The handle storage 158 may also have lids 166 that fit on top of the corresponding storage cavities 162a/b to keep the blades 118 contained and in place, as illustrated in FIGS. 7-11. Additionally, the handle storage 158 may have magnets 170 embedded therein, as illustrated in FIGS. 16-18 and 20, to retain the replaceable blades 118 when the lids 166 are removed. While the storage cavities described herein pertain to handle storage, it is envisioned that the storage cavities may alternatively, or additionally, be present on the knife cover/sheath. Therefore, any pieces, parts, components, or mechanisms described herein that relate to the storage cavity or corresponding lid of the handle storage are also applicable to sheath storage that can have one or more storage cavities and lids.

As mentioned above, the knife 102 may include handle storage 158, which can include at least one storage cavity 162 and a corresponding lid 166. In some embodiments, the knife 102 may include two storage cavities 162a/b, wherein each storage cavity has a lid 166. As illustrated in FIGS. 11 and 17, in embodiments of the handle storage 158 having two storage cavities 162a/b, the storage cavities may be, but do not have to be, symmetrical with (i.e., mirror images of) each other and may be interconnected with pegs, pins, screws, or other similar fasteners. In some embodiments, these fasteners may penetrate through both storage cavities 162a/b as well as the tang 176 of the knife 102 to ensure that the handle storage 158 stays intact during knife use. However, it is anticipated that the fasteners may only penetrate through one storage cavity and a portion of the tang. For example, if the knife only has one storage cavity, then there is only one storage cavity through which the fasteners can penetrate.

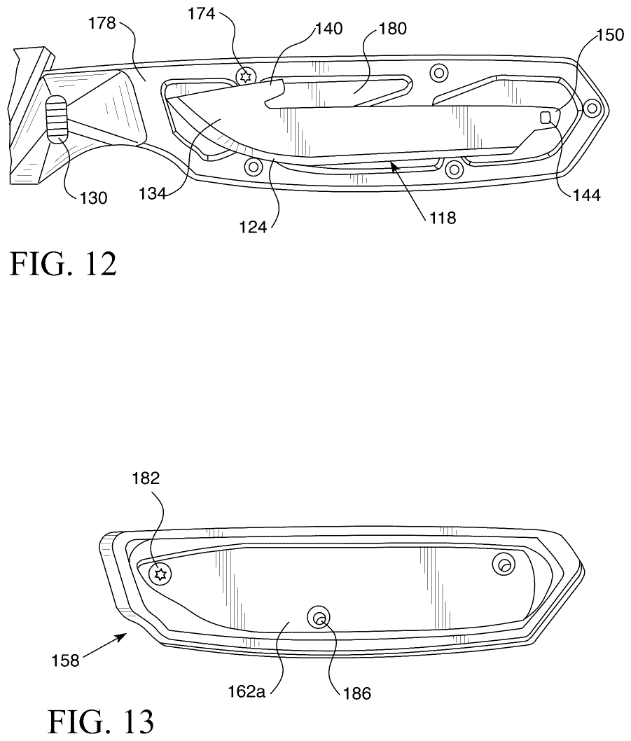

As illustrated in FIGS. 12-13 and 15-18 and 20, there may be three types of fasteners: some fasteners 174 that fasten portions of the tang 176 together, some fasteners 190 positioned in fastener openings 194 that fasten or guide the storage cavities 164 to the tang, and some fasteners 182 positioned in fastener openings 186 that penetrate completely through both storage cavities and the tang to securely hold all of those components together (i.e., the fasteners 182 affix the storage cavities 162 to the tang 176). In some cases, at least some of the fasteners 182 may penetrate completely through at least the storage cavity portions of the handle storage 158 while other of the fasteners 190 may be limited to connecting the interior walls of the storage cavities together in which case they may either fasten or, if they have no fastening capabilities (i.e., they are not threadedly attached) they may act more simply as guide posts to assist with keeping all of the knife components correctly aligned.

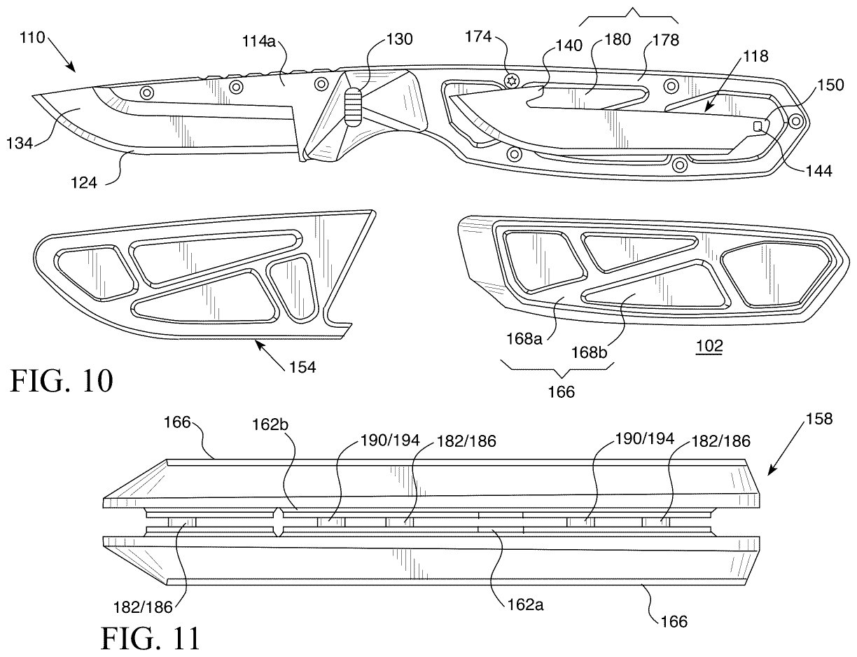

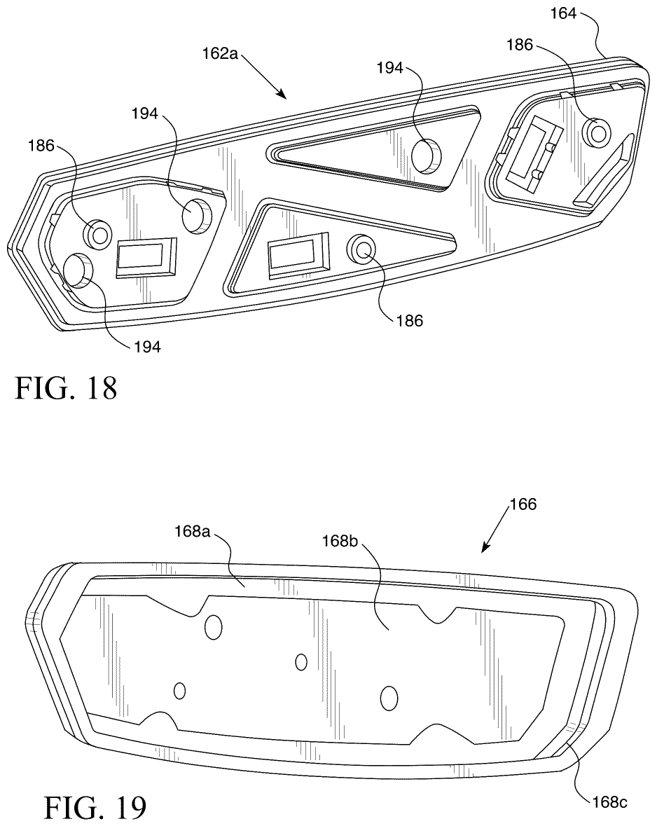

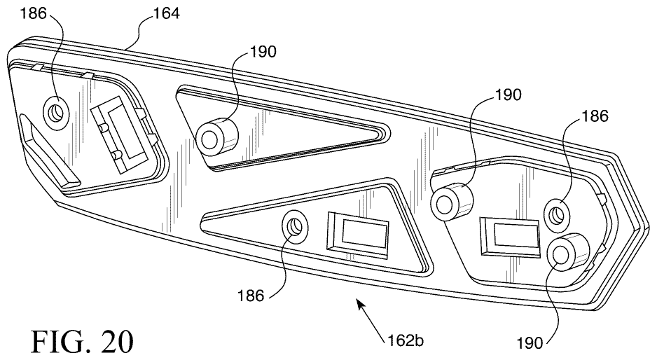

For example, as illustrated in FIGS. 17 and 20, fastener/guidepost 190 can be a smooth cylindrical post that is built in to at least one storage cavity 162, penetrates through openings in the tang 176 (for example, openings in the tang interior 180), and, as illustrated in FIGS. 17-18, can be received in a guidepost receiving cavity 194 that is present on a second storage cavity. And as illustrated in FIGS. 13, 15, 18 and 20, fasteners 182 may be threaded screws that penetrate through fastener openings 186 present in at least one storage cavity 162, through openings in the tang 176 (for example, openings in the tang interior 180), and have a threaded connection with fastener openings 186 present in the other storage cavity. As illustrated in FIG. 8, the tang interior 180 may have a pattern with openings (for example, a honeycomb pattern). However, a pattern is not required and the tang interior 180 may be more uniform in form (for example, solid, as illustrated in FIG. 10, or with openings similar to the tang frame 178, as illustrated in FIG. 9).

As illustrated in FIGS. 13, 15-16, 18, and 20, the handle storage 158 can have three holes 186 for fasteners and, therefore, three fasteners 182 that penetrate completely through the storage cavity portions. FIGS. 16 and 18 illustrates these three holes 186 for fasteners 182 as well as three additional holes 194 for fasteners 190 that can connect and/or align the interior walls to each other. FIG. 17 illustrates how the three guide holes 194 can be channels for guideposts 190 that keep the two storage cavities 162a/b connected (i.e., there is continuous contact between the two storage cavities), whereas the three holes or channels 186 for fasteners 182 may allow for slight gaps between the two storage cavities since the fasteners can depend on the threaded engagement between both storage cavities 162a/b to keep the two pieces connected (i.e., the protrusion on one storage cavity may not make contact with the receiving hole on the other storage cavity). As illustrated in FIG. 10, the holes for fasteners 174 may be strategically placed so that their penetration through points on the tang 176 fall outside the placement of the blades 118 when in their storage position. Some fasteners, such as fasteners 182, may be placed in a position that overlaps with the blades 118, though. In those cases, the threaded fasteners 182 may have beveled holes 186 so that the end of the threaded fastener is flush with the surface on which the blades 118 make contact, as illustrated in FIG. 13, and the blades are positioned laterally outward from the fasteners.

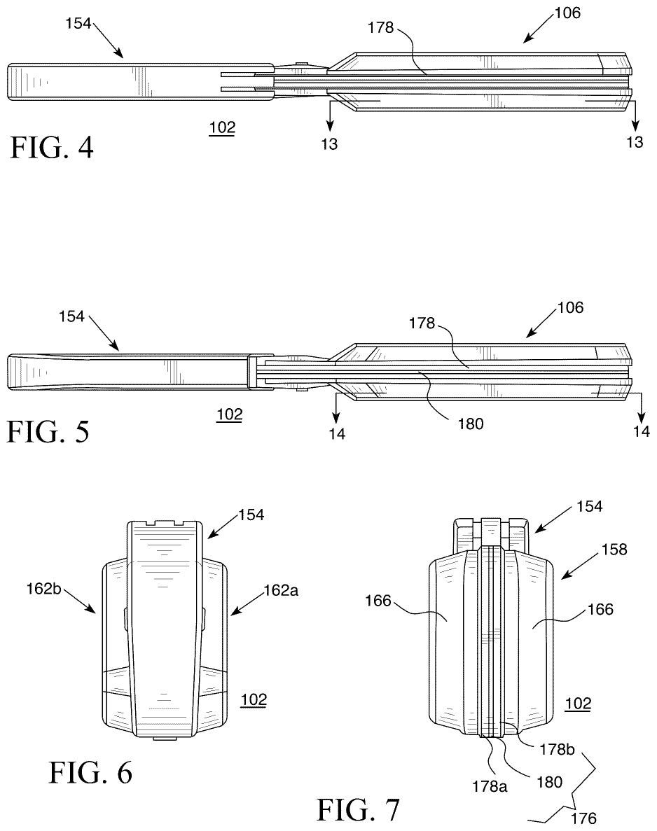

The storage cavities 162a/b, as illustrated in FIGS. 4-5 and 7, may be mirror images of each other and may sandwich the tang 176, which can be comprised of a tang frame 178 and a tang interior 180. Therefore, they can have the same height, depth, and length as each other but are not interchangeable on the tang 176. In some embodiments, however, the storage cavities may have one or more different dimensions. For example, they may have the same height and length but different depths, thereby holding different number of blades, as described as an alternative option in more detail below. In another example, the height and depth may be the same, but the lengths may be different. In yet another example, the length and depth may be the same, but the heights may be different. And in some cases, none of the dimensions between the two storage cavities may be the same.

The storage cavity 162 may be sized to receive and store at least one blade 118 that is similarly sized to the blade 110 attached to the blade carrier 114. For example, in some cases, the depth of the storage cavity 162 may be slightly more than the width of a predetermined number of blades 118, thereby enabling up to the predetermined number of blades to be stored in each storage cavity. For example, if the storage cavity 162 is slightly deeper than the width of two blades 118, then it may fit up to two blades, and if the storage cavity is slightly deeper than the width of three blades, then it may fit up to three blades, and so on and so forth. The storage cavity 162 may be relatively flat on its interior and exterior facing walls, as illustrated in FIGS. 13-15 so as not to scratch or mar the blades 118. In some cases, at least a portion of the walls of the storage cavity 162 may be a different (for example, softer) material than the remainder (for example, the frame) of the storage cavity.

In addition to the storage cavities 162a/b, the handle storage 158 may include corresponding lids 166. As illustrated in at least FIGS. 8-10 and 17, the lids 166 may be comprised of a lid frame 168a and a lid insert 168b. The lid insert 168b may be a solid piece to properly retain the blades 118, and the lid frame 168a may be a skeleton frame such that you can see the lid insert through the openings in the lid frame.

The lids 166 may have a toolless attachment to the storage cavity 162. For example, the lids 166 may attach to the storage cavity 162 using a snap fit, a slide fit, a rim/lip sealing mechanism 168c/164, or a friction fit. The lid 166 may be approximately the same size and shape as the opening of the storage cavity 162 such that removal of the lid enables a user to see and access the entirety of the storage cavity. In embodiments where the lid 166 attaches with a snap or friction fit, a user may remove the lid by sliding something narrow (for example, a finger pad or fingernail) into the seam between the lid 166 and the storage cavity 162 and pulling the lid away from the storage cavity. In embodiments where the lid 166 attaches with a slide fit, the user may push or pull the lid in a predetermined direction and the lid 166 may slide along rails or a seam until it is mostly or completely removed from the storage cavity 162. As shown in FIG. 17, the storage cavity 162 can have a raised outer lip 164 along an outer edge around which a rim 168c on the lid 166 can secure. In some cases, this rim/lip sealing mechanism 168c/164 creates a snap fit connection. In other cases, the rim/lip sealing mechanism 168c/164 allows the lid 166 to slide onto, and remain attached to, the storage cavity 162.

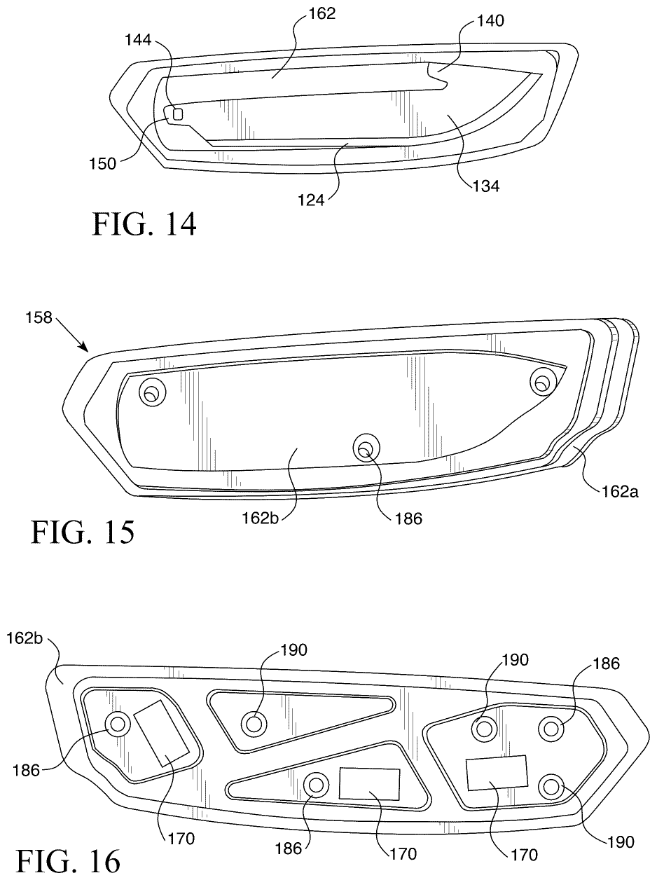

Once the lid 166 is removed, the blades 118 may be exposed in the storage cavity 162 of the handle storage 158, as illustrated in FIG. 14. Therefore, to ensure the blades 118 do not fall out of the knife 102 when the lid 166 is removed, magnet(s) 170 may be employed to create a magnetic connection between the handle storage 158 and the blades. For example, as illustrated in FIGS. 16-17, 18, and 20, a plurality of magnets 170 may be positioned at various locations within the handle storage 158 to create multiple magnetic connection points with the blades 118. In some cases, the magnets 170 may all be located on one side of the tang 176 and used for both sides of the handle storage 158 (i.e., the magnets may be deep enough and strong enough to retain blades stored in both storage cavities 162a/b even though they are located on a first side of the tang and are, therefore, further from the blades 118 that are located in the opposing, second storage cavity than they are the blades located in the first side). In other cases, as illustrated in FIG. 17, each storage cavity 162a/b may have its own set of magnets 170 to retain its corresponding blades 118.

In some cases, the tang 176 may be comprised of a frame 178 surrounding a patterned interior 180. For example, as illustrated in FIGS. 8-10 and 12, the tang 176 may be comprised of two outer, skeleton pieces 178 that sandwich a solid or non-solid (for example, honeycomb patterned) interior 180. The frame 178 and the interior 180 may be made from the same material, or they may be comprised of separate materials. In one example, the frame 178 and the interior 180 may be made from magnetic metals that that can help distribute the magnetic charge to assist with retention of the blades 118 in the storage cavity 162. In other cases, as mentioned above, the frame 178 and interior 180 may be made of different materials, either of which may or may not be magnetic. For example, to minimize the weight of the knife 102, the frame 178 may be made of a stronger, denser, and/or heavier material such as stainless steel, while the supportive interior 180 can be made of a lighter, less dense, and/or weaker material such as aluminum or titanium. This helps ensure the integrity of the knife 102 while minimizing weight where there are fewer stress points, such as the skeleton interior 180.

The magnets 170 may be positioned such that they are covered by the interior wall of each storage cavity 162a/b, as illustrated in FIGS. 17-18 and 20, where they are not visible or accessible when the lid 166 is removed from the storage cavity, as illustrated in FIGS. 13 and 15. The magnets can be embedded between the tang 176 and the handle storage 158 (for example, positioned on the interior of each storage cavity), as illustrated in FIG. 17.

As illustrated in FIGS. 16, 18, and 20, the knife 102 may have three magnets 170 for each storage cavity 162a/b (i.e., three on each side of the tang 176), for a total of six magnets in the knife 102. In some embodiments, however, if magnets 170 are only located on one side of the knife 102, there may be fewer than six magnets. For example, three magnets may be present on one side of the tang 176 and none on the other side. In embodiments where there are three magnets 170 on at least one side, the first magnet may be located near a distal end of the handle, a second of the three magnets may be located centrally on the handle, and a third of the three magnets may be located near a proximal end of the handle, as illustrated in FIG. 16. In some embodiments, each storage cavity 162a/b can include at least one magnet 170.

While it is useful to be able to carry a knife 102 with built in replaceable handle storage, there are times when a user may wish to travel as lightly as possible and, therefore, this knife is designed to be used on its own without the additional handle storage 158 or extra blades. More specifically, as shown in FIGS. 8 and 9, the knife 102 can be useable without the inclusion of the knife sheath 154, handle storage 158, or extra blades 118. Additionally, to further eliminate weight from the knife 102, a skeleton tang 176 may be employed, as illustrated in FIGS. 8 and 9 and described in more detail above. As illustrated in FIGS. 8-10, each side of the frame of the skeleton tang may extend to further include the blade carriers 114. For example, the first blade carrier 114a may be a continuous piece with a first tang frame member 178a, and the second blade carrier 114b may be a continuous piece with a second tang frame member 178b. The skeleton interior can then be sandwiched between the two tang frame member portions, and the member can be positioned between the first blade carrier 114a and the second blade carrier 114b.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A knife, comprising:
a blade;
a tang; and
handle storage;
wherein
the handle storage comprises two storage cavities and two corresponding lids,
at least one of the storage cavities is larger in size than the blade, and
the handle storage is removable from the tang.

2. The knife of claim 1, wherein the blade is a replaceable blade.

3. The knife of claim 2, further comprising a blade carrier to which the replaceable blade is transiently attached.

4. The knife of claim 3, further comprising a replaceable blade lock release button.

5. The knife of claim 1, wherein the storage cavities are located on opposing sides of the tang.

6. The knife of claim 5, further comprising at least three additional blades, wherein the at least three additional blades are dimensioned similarly to the blade and fit within one of the storage cavities.

7. The knife of claim 5, wherein fasteners affix the storage cavities to the tang.

8. The knife of claim 7, wherein
at least two additional blades are dimensioned similarly to the blade and fit within at least one of the storage cavities, and
the additional blades are positioned laterally outward from the fasteners.

9. The knife of claim 1, wherein the storage cavities are mirror images of each other such that their positions are not interchangeable on the tang.

10. The knife of claim 1, wherein the knife further comprises a first locking mechanism to retain the blade.

11. The knife of claim 10, wherein the knife further comprises a second locking mechanism to fix the first locking mechanism in place.

12. The knife of claim 1, wherein
the tang has a tang frame and a tang interior,
the tang frame is made of a first material, and
the tang interior is made of a second material that is different from the first material.

13. The knife of claim 12, wherein the tang frame is a skeleton frame, and the tang interior has a honeycomb pattern.

14. The knife of claim 1, wherein at least one magnet is embedded between the tang and the handle storage.

15. The knife of claim 14, wherein the at least one magnet is comprised of three magnets, and all three magnets are located on the same side of the tang.

16. The knife of claim 15, wherein
a first of the three magnets is located near a distal end of the handle,
a second of the three magnets is located centrally on the handle, and
a third of the three magnets is located near a proximal end of the handle.

17. The knife of claim 1, wherein each storage cavity includes at least one magnet.

18. The knife of claim 1, wherein the storage cavities each have a raised outer lip along an outer edge around which rims on their corresponding lids are securable.

19. The knife of claim 18, wherein each lid has a snap fit connection with its corresponding storage cavity.

20. A knife, comprising:
a blade carrier;
a removable blade connected to the blade carrier;
a tang; and
at least one storage cavity having a corresponding removable lid;
wherein
the storage cavity is removable in its entirety from the knife,
the storage cavity connects to one of the blade carrier or the tang, and
the storage cavity has a raised outer lip along an outer edge around which a rim on the corresponding removable lid is securable such that the lid has a snap fit with the storage cavity.
